(19) United States
(12) Patent Application Publication
(10) Pub. No.: US 2015/0089335 A1
(43) Pub. Date: Mar. 26, 2015

(54) SMART PROCESSING OF AN ELECTRONIC DOCUMENT

(71) Applicant: ABBYY Development LLC, Moscow (RU)

(72) Inventor: Ivan Yurievich Korneev, Moscow (RU)

(21) Appl. No.: 14/488,672

(22) Filed: Sep. 17, 2014

Related U.S. Application Data
(60) Provisional application No. 61/882,618, filed on Sep. 25, 2013.

(30) Foreign Application Priority Data
Dec. 25, 2013 (RU) 2013157758

(51) Int. Cl. G06F 17/24; G06K 9/00

(52) U.S. Cl. CPC G06F 17/24; G06K 9/00449
USPC 715/202

(57) ABSTRACT

Disclosed are methods, systems, and computer-readable mediums for processing an electronic document. An electronic document is received, where the electronic document comprises an image that contains visually represents text, and where the electronic document lacks text data corresponding to the visually represented text of the image. The image that contains the visually represented text is automatically recognized, where the automatic recognition occurs in a background mode such that display of the electronic document to a user is unaffected. A text layer comprising recognized data is generated, where the recognized data is based on the automatic recognition of the image that contains visually represented text. The text layer is inserted behind the image that contains visual represented text such that it is hidden from the user when the electronic document is displayed, where the hidden text layer is configured to allow the user to perform a user operation on text corresponding to the recognized data. A result of the user operation is saved as part of the electronic document.

### CROSS REFERENCE TO RELATED APPLICATIONS

This application claims the benefit of priority under 35 USC 119 to Russian Patent Application No. 2013157758, filed Dec. 25, 2013. This application also claims the benefit of priority to the Provisional Patent Application No. 61/882,618, filed Sep. 25, 2013; the disclosures of the priority applications are incorporated herein by reference.

### BACKGROUND

Working with an image-only document that contains visual representations of text can be a difficult process for a user, as the image format of the document is such that the visually represented text is not directly accessible to the user (because it is stored as an image). Accordingly, this type of document does not allow a user to work with the text content of the document unless the visual text is first recognized and converted to accessible text, typically with optical character recognition (OCR) technologies. Thus, for example, if a document is image-only, one cannot easily perform a search of the document for the text, or perform various other operations on the text (such as selecting the text, copying features of the text, editing the text, and so forth).

One of the electronic file types widely used to store documents is the Portable Document Format (PDF). The PDF format is popular because it has become a universal format, and files in this format are able to be displayed similarly on all computers having software that can read PDF files. This is possible because a PDF file contains detailed information about the configuration of text, a character map, and the graphics of the document. However, a distinction can be made between two types of PDF files. The first type of PDF is a searchable PDF, which includes a text layer and pictures. The area of the PDF file that contains the text (either fully or partially) of the document is generally referred to as the text layer. Searching, selecting, copying, and editing of text is possible in a searchable PDF, as is copying the images. The second type of PDF is an image-only PDF. This type of PDF only contains images and does not contain any text layers. Accordingly, with an image-only PDF, any text that is visually represented in an image therein cannot be readily edited, marked, or searched without additional processing or file conversion.

In addition to an image-only PDF, another widely used image-only format is the Tagged Image File Format (TIFF) format. The TIFF format for documents is a popular format for storing rasterized graphic images. As is known to those of skill in the art, a rasterized image is an image that includes a grid network of pixels or colored dots (usually rectangular) to be displayed on the screen of an electronic device or to be printed on paper. Other examples of documents types that are merely images also exist. For example, a photograph that was produced using a digital camera may be stored in JPEG format, PNG format, BMP format, RAW format, and so forth.

### SUMMARY

Disclosed herein are methods, systems, and computer-readable mediums for smart processing of an electronic document. One embodiment relates to a method, which comprises receiving, by a processing device, an electronic document, wherein the electronic document comprises an image that contains visually represents text, and wherein the electronic document lacks text data corresponding to the visually represented text of the image. The method further comprises automatically recognizing the image that contains visually represented text, wherein the automatic recognition occurs in a background mode such that display of the electronic document to a user is unaffected. The method further comprises generating a text layer comprising recognized data, wherein the recognized data is based on the automatic recognition of the image that contains visually represented text. The method further comprises inserting the text layer behind the image that contains visual represented text such that it is hidden from the user when the electronic document is displayed, wherein the hidden text layer is configured to allow the user to perform a user operation on text corresponding to the recognized data. The method further comprises saving, in a storage device, a result of the user operation as part of the electronic document. The created text layer created may be not saved by default (i.e. the document type may not change).

Another embodiment relates to a system comprising a processing device. The processing device is configured to receive an electronic document, wherein the electronic document comprises an image that contains visually represents text, and wherein the electronic document lacks text data corresponding to the visually represented text of the image. The processing device is further configured to automatically recognize the image that contains the visually represented text, wherein the automatic recognition occurs in a background mode such that display of the electronic document to a user is unaffected. The processing device is further configured to generate a text layer comprising recognized data, wherein the recognized data is based on the automatic recognition of the image that contains visually represented text. The processing device is further configured to insert the text layer behind the image that contains visual represented text such that it is hidden from the user when the electronic document is displayed, wherein the hidden text layer is configured to allow the user to perform a user operation on text corresponding to the recognized data. The processing device is further configured to save, in a storage device, a result of the user operation as part of the electronic document. The created text layer created may be not saved by default (i.e. the document type may not change).

Another embodiment relates to a non-transitory computer-readable medium having instructions stored thereon, the instructions comprise instructions to receive an electronic document, wherein the electronic document comprises an image that contains visually represents text, and wherein the electronic document lacks text data corresponding to the visually represented text of the image. The instructions further comprise instructions to automatically recognize the image that contains the visually represented text, wherein the automatic recognition occurs in a background mode such that display of the electronic document to a user is unaffected. The instructions further comprise instructions to generate a text layer comprising recognized data, wherein the recognized data is based on the automatic recognition of the image that contains visually represented text. The instructions further comprise instructions to insert the text layer behind the image that contains visual represented text such that it is hidden from the user when the electronic document is displayed, wherein the hidden text layer is configured to allow the user to perform a user operation on text corresponding to the recognized data. The instructions further comprise instructions to save, in a storage device, a result of the user operation as part of the electronic document. The created text layer created may be not saved by default (i.e. the document type may not change).

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1A shows a screen shot of a searchable PDF document.

FIG. 1B shows a screen shot of an image-only PDF document.

FIG. 2 shows a flow diagram of smart processing of an image-only document in accordance with one embodiment.

FIG. 3 shows a flow diagram of a recognition process in accordance with one of embodiment.

FIG. 4 shows an example of the structure of an image-only document that is produced in accordance with one embodiment.

FIG. 5 shows a computer platform that may be used to implement the techniques and methods described herein.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

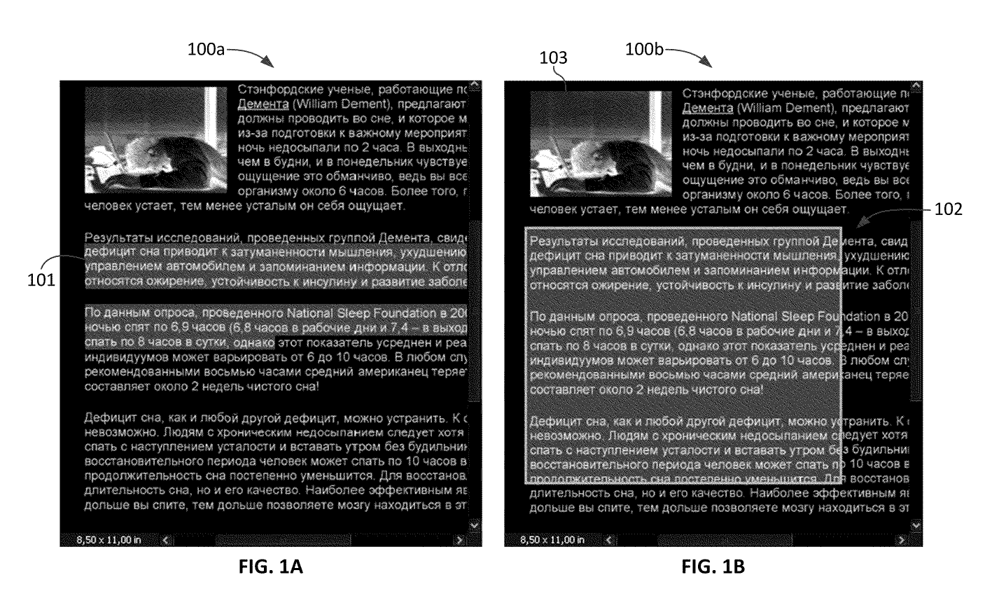

The term image-only document refers to a document that contains an image having a visual representation of text, but does not contain text data corresponding to the visual representation (i.e., text that is selectable as text, editable as text, and/or searchable as text). In other words, ASCII data, UTF-8, other encoding data, etc. is not stored (contained) in an image-only document for the visually represented text of the image. Thus, such an image-only document may contain a representation of text, but it is in the form of an image and is stored as an image format (e.g., as part of an image or as a graphic of the text, etc.). Image-only documents may not support text-based searches, selection, or copy capabilities. This problem can be illustrated with reference to the two example documents of FIG. 1A (a searchable PDF) and FIG. 1B (an image-only PDF).

Referring to FIG. 1A, a screen shot 100a of a searchable PDF is shown. As noted above, one feature of this format is that a document of this type contains a text layer that allows for the searching of text, selection of text, copying of text, and editing of text, etc. FIG. 1A demonstrates that text 101 of the document may be selected. For example, text 101 may be selected a line at a time, a word at a time, or otherwise, by using one of any well-known methods (such as by using a mouse). FIG. 1B is a screen shot 100b of an image-only PDF, which has an image 102 that visually represents text. As noted above, one feature of this format is that a document of this type contains image data, where text is visually represented and therefore is not readily accessible. In this manner, text searching, selection, copying, and editing are not available without additional processing (e.g., optical character recognition). FIG. 1B demonstrates that the text of image 102 cannot be separated when it is part of image 102 and no additional processing has been applied. As a result, it is difficult to perform other additional operations on the text and picture 103 of the document, as the text and picture 103 are both part of a single image 102.

The present disclosure enables a user to work with text and pictures of an image-only document as if the user had explicitly initiated machine recognition of the document. Explicit recognition as discussed herein refers to the process in which character recognition is launched pursuant to an explicit user command and according to corresponding settings of an application. A text layer with recognized text is added to the document so that the user may perform a text-based search and other operations (e.g., selection, copying, etc.) directly within the image-only document. The methods, systems, and computer-readable mediums disclosed herein allow a user to manipulate recognized text (and other objects) in an image-only document without first explicitly applying recognition processes to the images of the document. This capability is particularly useful for users who do not suspect that there are various types of documents and consequently whether or not it is possible to work with the content of these documents.

According to one embodiment, when an image-only document is opened, a process to recognize the document is launched in a background mode. Background (or in other word, implicit) recognition as discussed herein refers to recognition that is launched without an explicit user command. Any of the processes disclosed herein may be implemented as an individual application, or as part of another application (e.g., as a plugin for an application, etc.). As a result of the background recognition process, a text representation of the document is created, and thus, text-based search and several other user operations may then be performed directly within the image-only documents. After the user performs his or her desired operation on recognized object, the document may be saved and the results of the user operations are stored. The text data that is created automatically during the background recognition process is not saved by default in long term memory, and the document type does not change. An exception is when the text layer was created using an explicit user command (e.g., “Recognize”, etc.). A user may edit default settings (e.g., via user interface) such that the generated text data is also saved (which may result in the document being stored according to a format that supports searchable text).

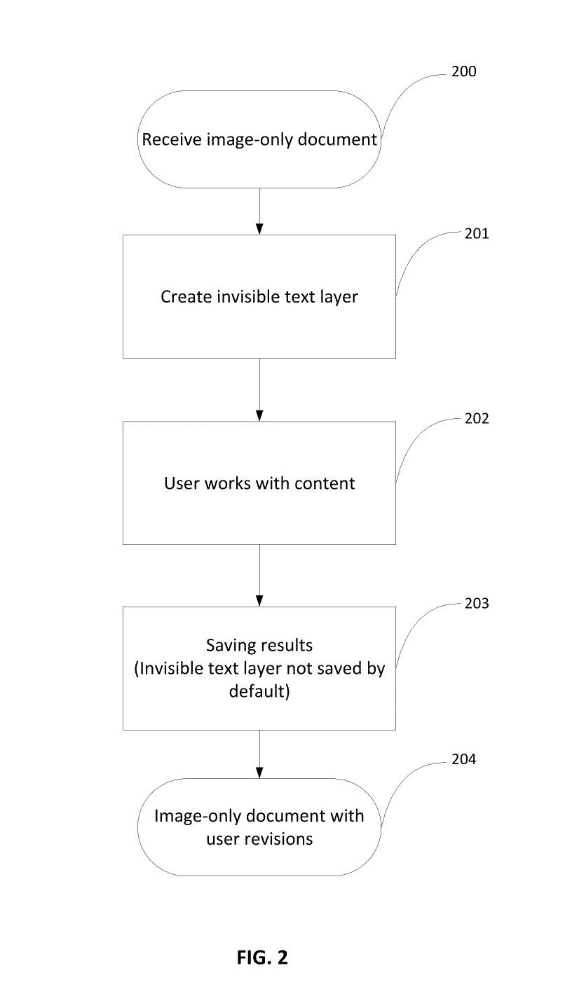

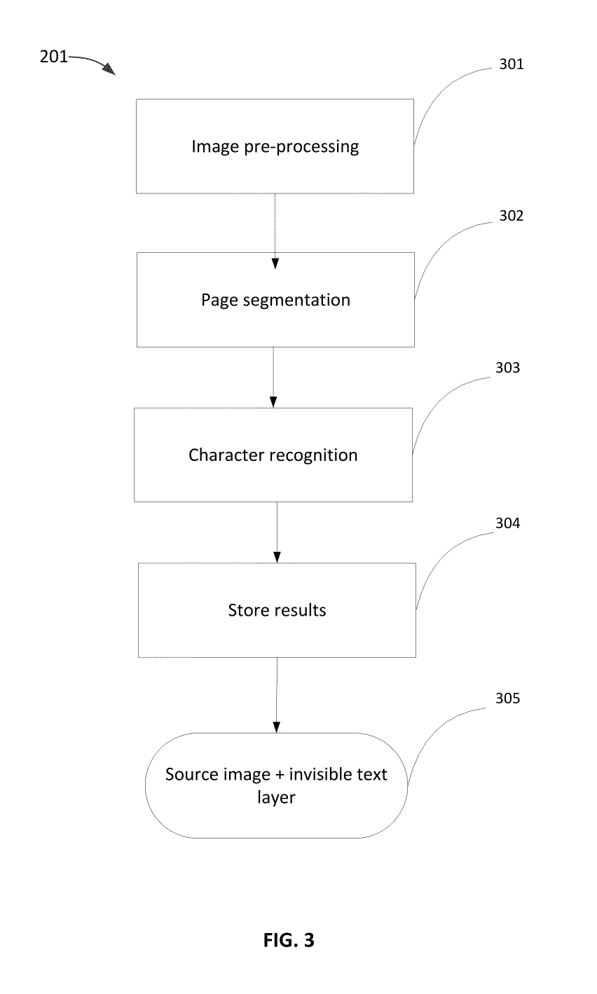

Referring to FIG. 2, a flow diagram for smart processing of an electronic document is shown, according to one embodiment. In alternative embodiments, fewer, additional, and/or different actions may be performed. Also, the use of a flow diagram is not meant to be limiting with respect to the order of actions performed. As input, an image-only document is received (200). As an example, the image-only document may be a document of any of the following types: image-only PDF, TIFF, JPEG, PNG, BMP, GIF, RAW, and so forth. It should be understood that the scope of the present disclosure is not limited to an image-only document of a particular file type. After the image-only document is input, it is recognized during a recognition process in the background mode (201). In general, optical character recognition is used to transform paper documents or images, such as documents in PDF format, into machine-readable, editable electronic files that support text-based searches. Typical optical character recognition software processes images of documents to distinguish text of the document. The software may include recognition algorithms, which can recognize symbols, letters, punctuation marks, digits, etc., and can store recognized items in a machine-editable format (e.g., a text encoded format). In the main embodiment, the recognition process may be initiated when the image-only document is opened by a user for viewing. In this manner, the recognition process is launched automatically without the user actively selecting a “recognize” button (or similar button) or issuing a command to explicitly commence recognition. From the perspective of a user, the process of recognition runs in the background (i.e., behind the scenes, without the user's active participation). The process of recognition results in the creation of at least one invisible (i.e. hidden) text layer including all of the text that is extracted from images of the document. In another embodiment, the recognition process may be at least partially based on a user selection. For example, a “copy” command may be issued when in response to a user dragging a selection box over a portion of visually represented text or another portion of the document. The selection area can then limit the recognition process to certain portion of the document so that the selected area is recognized immediately. The results of recognition (e.g., text or individual images) are therefore quickly available for use by a user. For example, the results of the recognition within the selection area can be copied into a clipboard so that the results may be later pasted from the clipboard. Thus, this embodiment allows recognition to run in the background mode as discussed above, but tailored to prioritize portions of the document as designated by the user. The recognition process (201) will be described in further details below with reference to FIG. 3.

After an image-only document is recognized, the user may then work with any document content (202). For example, the user may perform a full-text search (e.g., a search for a word throughout the text of the document). Working with the document content, such as performing a search, is possible because information related to characters recognized (e.g., coordinates [locations], types of characters) are generated from the source image of the document. As an example, a search may be launched automatically when characters are entered into a search bar that may be provided as part of a user interface. Because the document is automatically recognized in the background mode as discussed above, such a search can be launched simultaneously with the recognition process. As an example, at the moment that the user has entered a word (or character) for a search into a search bar, the recognition and search processes may work in parallel. The results of the search may then be displayed on the user interface after the recognition process (201) has completed and the invisible text layer has been produced. In one embodiment, exact matches obtained from the search may be visualized for the user using any one of the known methods (e.g., highlighting or demarcating matched search terms, etc.).

In addition to performing searches, the user may take other actions/operations with respect to recognized text. For example, text may be selected and copied. As another example, the text may be marked (e.g., the text may be highlighted or otherwise demarcated). As another example, an annotation may be applied in the form of an underline, strikethrough, or otherwise. As another example, the text may be commented on. In one embodiment, hyperlinks, e-mail addresses, and other shortcuts are automatically recognized and become active (e.g., clickable) after the recognition process.

In addition to operations on the text, the method disclosed herein allows a user to work with pictures that were detected in the image-only document via the recognition process. For example, any pictures can be copied, commented on, edited, annotated, etc.

It should be understood, that the various user operations discussed herein are provided for illustration and do not limit the scope of this disclosure. These operations can be performed on any recognized content of an image-only document, which has been recognized in a background mode and where an invisible text layer has been produced in accordance this disclosure.

After the user performs desired operations on the document (based on the received invisible text layer that contains recognized characters), the results of such operations may be saved in storage, for example, in a memory or a hard drive (203). In one embodiment, by default, only the results of the operations are stored, and the invisible text layer created during the recognition process (201) is not retained after the document is closed (or saved). This produces an image-only document that contains the user revisions (which are stored in an image format either separately or as part of the images of the image-only document) (204). An exception is when the text layer was created using an explicit user command (e.g., “Recognize”). In another embodiment, the default option may be changed by a user (e.g., via editing default setting using user interface) and the user may explicitly designate that the invisible text layer should be stored. In this embodiment, the file may is stored according to a searchable document format, as compared to an image-only document.

Referring to FIG. 3, a flow diagram for the recognition process that creates the invisible text layer (e.g., recognition process (201) as discussed above) is shown according to one embodiment. During process (201), an image-only document is analyze and transformed to include a text data for visually represented text of the document, and several steps are performed. In alternative embodiments, fewer, additional, and/or different actions may be performed. Also, the use of a flow diagram is not meant to be limiting with respect to the order of actions performed. An image of the image-only document (e.g., a page, a portion of a page) undergoes preprocessing (301) in order to provide a high quality image for recognition. For example, a rasterized image of the image-only document (200) may be provided as input to the recognition system. Providing a high quality image through pre-processing helps to avoid inaccuracies and recognition issues. For example, if visually represented text is noisy (e.g., text overlaid on a background image), is not sharp (e.g., blurred, defocused), or has low contrast or other issues, the accuracy of recognition may decrease. Thus, image preprocessing (301) attempts to improve the image quality before the image is further processed with recognition algorithms.

Preprocessing may include a number of processing techniques. In one embodiment, the skew in the image is corrected (e.g., straightening of lines within the image). In another embodiment, pages of the document are detected, and the orientation of each page of the document is determined and corrected if necessary (e.g., pages may be rotated by 90 degrees, 180 degrees, 270 degrees, or an arbitrary amount of degrees such that a page is properly orientated). In another embodiment, noise is filtered from the image. In another embodiment, the sharpness and contrast of the image may be increased or adjusted. In another embodiment, the image may be adjusted and transformed into a certain system format which is optimal for recognition. As one example, during preprocessing, defects in the form of a blur or unfocused text may be detected, corrected, and/or removed using the methods described in U.S. patent application Ser. No. 13/305,768, entitled “Detecting and Correcting Blur and Defocusing.”

A detected page of the pre-processed image (or the preprocessed image as a whole) may be segmented (302), which includes detecting and analyzing the structural units of the image-only document. When the structural units are analyzed, several hierarchically organized logical levels are formed based on the structural units. In one embodiment, a page of the document being processed may be an item at the highest level, with a text block, an image, a table, etc., at the next level in the hierarchy, followed by an image, a table, etc. Thus, for example, a text block may consist of paragraphs, the paragraphs may consist of lines, the lines may consist of words, and a word in turn may consist of individual letters (characters). The characters, word, or structures formed from the characters (e.g., sentences, paragraphs, etc.) may be recognized by the optical character recognition software.

While the image-only document may be recognized by any known optical character recognition method, in one embodiment, the recognition process (303) includes advancing and checking hypotheses. A certain number of hypotheses are advanced about what is in the image based on general features of the image of character (s). These hypotheses are checked using various criteria. If one of the features is missing in the image of character, then checking the corresponding hypothesis may cease, therefore limiting the examination of variations of the feature at the early stages. In one embodiment, the recognition process makes hypotheses about individual characters and concurrently makes hypotheses about entire words. The results of optical character recognition of individual characters may also be used to advance hypotheses and as to rate words formed from the characters. A dictionary may also be references as an additional check of the accuracy of the hypotheses about complete words.

The recognition results are then stored (304). By using the information obtained when the document structure was analyzed at step 302, the electronic document is synthesized, i.e., the lines and paragraphs are joined in accordance with the source document. In one embodiment, the background recognition process may differ from the recognition process described above. For example, the background recognition process may process each page of a multi-page document as a separate document. This provides the advantage of minimizing processing time, as time is not spent analyzing the detailed structure of the entire document as a whole (e.g., the hierarchy of headings and subheadings of different levels within the whole document) during steps 302 and 304, because each page is treated as an individual document. The background recognition process of different pages may be performed independently or concurrently with processing being performed for a page that the user is presently viewing. Additionally, background recognition may begin with the page the user is working on, and then may independently or concurrently move to additional pages of the document.

As a result of the recognition process the page is transformed from a set of graphic images into text symbols, and information is produced about the layout (coordinates) of the text and pictures in the source image, etc. This output is stored in a text layer that is invisible (i.e. hidden) to the user (305).

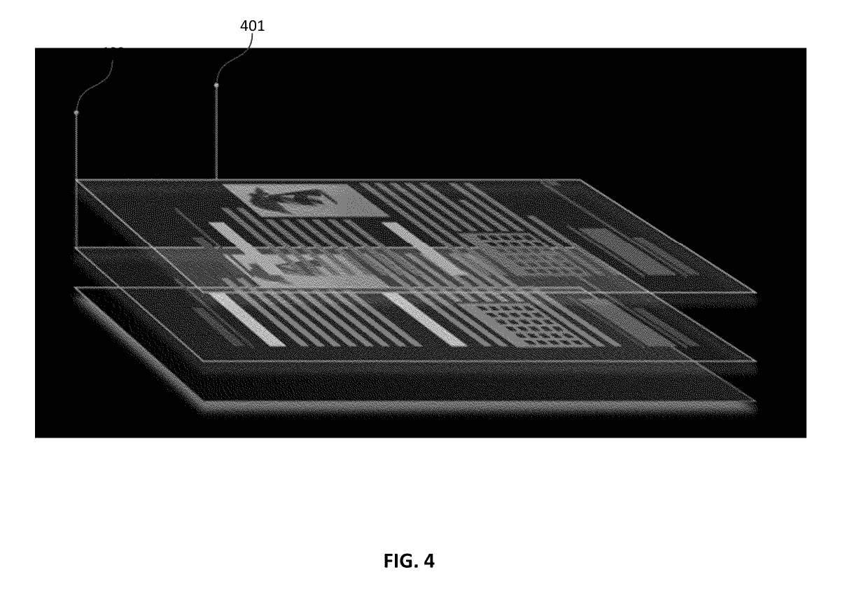

Referring to FIG. 4 an example of the structure of an image-only document having an invisible (i.e. hidden) text layer is shown according to one embodiment. The source image of the page (401) is maintained in such a document, and the text layer that contains the recognized text is placed behind the image (402) and is hidden from the user's view.

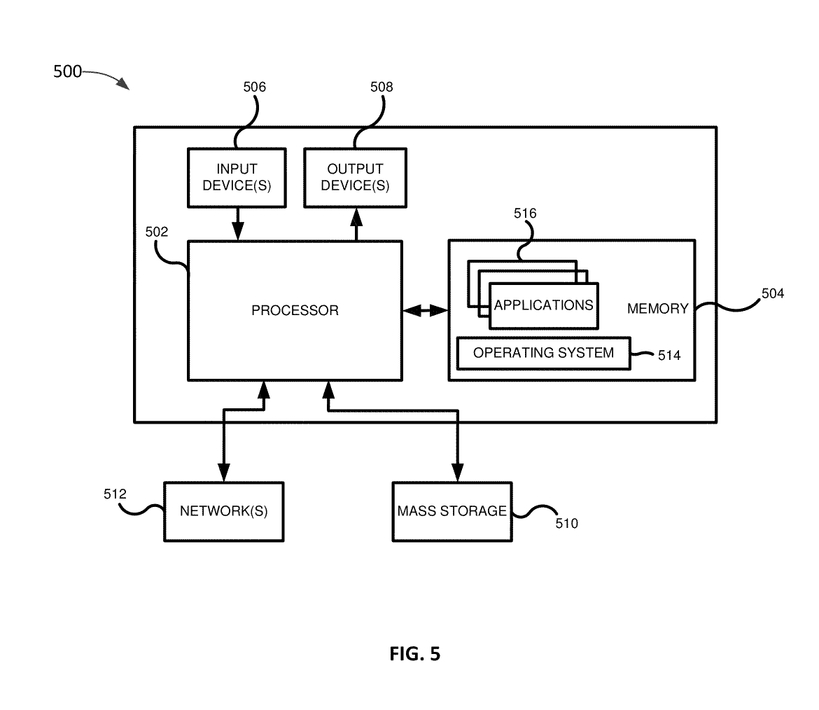

FIG. 5 shows computer platform 500 that may be used to implement the techniques and methods described herein. Referring to FIG. 5, the computer platform 500 typically includes at least one processor 502 coupled to a memory 504 and has an input device 506 and a display screen among output devices 508. The processor 502 may be any commercially available CPU. The processor 502 may represent one or more processors and may be implemented as a general-purpose processor, an application specific integrated circuit (ASIC), one or more field programmable gate arrays (FPGAs), a digital-signal-processor (DSP), a group of processing components, or other suitable electronic processing components. The memory 504 may include random access memory (RAM) devices comprising a main storage of the computer platform 500, as well as any supplemental levels of memory, e.g., cache memories, non-volatile or back-up memories (e.g., programmable or flash memories), read-only memories, etc. In addition, the memory 504 may include memory storage physically located elsewhere in the computer platform 500, e.g., any cache memory in the processor 502 as well as any storage capacity used as a virtual memory, e.g., as stored on a mass storage device 510. The memory 504 may store (alone or in conjunction with mass storage device 510) database components, object code components, script components, or any other type of information structure for supporting the various activities and information structures described herein. The memory 504 or mass storage device 510 may provide computer code or instructions to the processor 502 for executing the processes described herein.

The computer platform 500 also typically receives a number of inputs and outputs for communicating information externally. For interfacing with a user, the computer platform 500 may include one or more user input devices 506 (e.g., a keyboard, a mouse, touchpad, imaging device, scanner, etc.) and a one or more output devices 508 (e.g., a Liquid Crystal Display (LCD) panel, a sound playback device (speaker). For additional storage, the computer platform 500 may also include one or more mass storage devices 510, e.g., floppy or other removable disk drive, a hard disk drive, a Direct Access Storage Device (DASD), an optical drive (e.g., a Compact Disk (CD) drive, a Digital Versatile Disk (DVD) drive, etc.) and/or a tape drive, among others. Furthermore, the computer platform 500 may include an interface with one or more networks 512 (e.g., a local area network (LAN), a wide area network (WAN), a wireless network, and/or the Internet among others) to permit the communication of information with other computers coupled to the networks. It should be appreciated that the computer platform 500 typically includes suitable analog and/or digital interfaces between the processor 502 and each of the components 504, 506, 508, and 512, as is well known in the art.

The computer platform 500 may operate under the control of an operating system 514, and may execute various computer software applications 516, comprising components, programs, objects, modules, etc. to implement the processes described above. In particular, the computer software applications may include an optical character recognition application, an invisible text layer creation application, an image-only and searchable document display/editing application, a dictionary application, and also other installed applications for recognizing text within an image-only document and transforming the document so that the user may then search and perform other operations (e.g., editing, selection, copying, etc.) on recognized text and pictures directly within the image-only document. Any of the applications discussed above may be part of a single application, or may be separate applications or plugins, etc. Applications 516 may also be executed on one or more processors in another computer coupled to the computer platform 500 via a network 512, e.g., in a distributed computing environment, whereby the processing required to implement the functions of a computer program may be allocated to multiple computers over a network.

In general, the routines executed to implement the embodiments may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements of disclosed embodiments. Moreover, various embodiments have been described in the context of fully functioning computers and computer systems, those skilled in the art will appreciate that the various embodiments are capable of being distributed as a program product in a variety of forms, and that this applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD-ROMs), Digital Versatile Disks (DVDs), flash memory, etc.), among others. The various embodiments are also capable of being distributed as Internet or network downloadable program products.

In the above description numerous specific details are set forth for purposes of explanation. It will be apparent, however, to one skilled in the art that these specific details are merely examples. In other instances, structures and devices are shown only in block diagram form in order to avoid obscuring the teachings.

Reference in this specification to “one embodiment” or “an embodiment” means that a particular feature, structure, or characteristic described in connection with the embodiment is included in at least one embodiment. The appearance of the phrase “in one embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

While certain exemplary embodiments have been described and shown in the accompanying drawings, it is to be understood that such embodiments are merely illustrative and not restrictive of the disclosed embodiments and that these embodiments are not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

What is claimed is:

1. A method comprising:
receiving, by a processing device, an electronic document, wherein the electronic document comprises an image that contains visually represents text, and wherein the electronic document lacks text data corresponding to the visually represented text;
automatically recognizing the image that contains visually represented text, wherein the automatic recognition occurs in a background mode such that display of the electronic document to a user is unaffected;
generating a text layer comprising recognized data, wherein the recognized data is based on the automatic recognition of the image that contains visually represented text;
inserting the text layer behind the image that contains visual represented text such that it is hidden from the user when the electronic document is displayed, wherein the hidden text layer is configured to allow the user to perform a user operation on text corresponding to the recognized data; and
saving, in a storage device, a result of the user operation as part of the electronic document.

2. The method of claim 1, wherein the text corresponding to the recognized data comprises text data received during the automatic recognition.

3. The method of claim 1, wherein the electronic document comprises at least one of an image-only PDF, a TIFF file, a JPEG file, a PNG file, a BMP file, a GIF file, and a RAW file.

4. The method of claim 1, wherein the user operation comprises at least one of performing a search of the text corresponding to the recognized data, selecting the text corresponding to the recognized data, copying the text corresponding to the recognized data, and marking the text corresponding to the recognized data.

5. The method of claim 1, wherein automatically recognizing, in the background mode, the image that contains visually represented text comprises using optical character recognition on the visually represented text.

6. The method of claim 1, wherein automatically recognizing, in the background mode, the image that contains visually represented text further comprises pre-processing the image prior to the recognition in order to increase accuracy of the recognition.

7. The method of claim 6, wherein pre-processing the image comprises at least one of correcting a skew in the image, correcting an orientation of the image, filtering the image, adjusting a sharpness of the image, adjusting a contrast of the image, and correcting a blur of the image.

8. The method of claim 1, wherein automatically recognizing, in the background mode, the image that contains visually represented text further comprises advancing and checking a hypothesis for a character.

9. The method of claim 1, wherein automatically recognizing, in the background mode, the image that contains visually represented text further comprises:
detecting and analyzing structural units of the electronic document; and
hierarchically organizing the structural units based on a type of each structural unit.

10. The method of claim 1, wherein automatically recognizing, in the background mode, the image that contains visually represented text occurs without the user actively initiating the recognition of the image that contains visually represented text.

11. The method of claim 1, wherein automatically recognizing, in the background mode, the image that contains visually represented text is initiated when the document is opened by user.

12. The method of claim 1, wherein automatically recognizing, in the background mode, the image that contains visually represented text is performed independently and concurrently with processing being performed for a page of the document that a user is presently working on.

13. A system comprising:
a processing device configured to:
receive an electronic document, wherein the electronic document comprises an image that contains visually represents text, and wherein the electronic document lacks text data corresponding to the visually represented text of the image;
automatically recognize the image that contains visually represented text, wherein the automatic recognition occurs in a background mode such that display of the electronic document to a user is unaffected;
generate a text layer comprising recognized data, wherein the recognized data is based on the automatic recognition of the image that contains visually represented text;
insert the text layer behind the image that contains visual represented text such that it is hidden from the user when the electronic document is displayed, wherein the hidden text layer is configured to allow the user to perform a user operation on text corresponding to the recognized data; and
save, in a storage device, a result of the user operation as part of the electronic document.

14. The system of claim 13, wherein the electronic document comprises at least one of an image-only PDF, a TIFF file, a JPEG file, a PNG file, a BMP file, a GIF file, and a RAW file.

15. The system of claim 13, wherein the user operation comprises at least one of performing search of the text corresponding to the recognized data, selecting the text corresponding to the recognized data, copying the text corresponding to the recognized data, and marking the text corresponding to the recognized data.

16. The system of claim 13, wherein automatically recognizing, in the background mode, the image that contains visually represented text comprises using optical character recognition on the visually represented text.

17. The system of claim 13, wherein automatically recognizing, in the background mode, the image that contains visually represented text further comprises:
detecting and analyzing structural units of the electronic document; and
hierarchically organizing the structural units based on a type of each structural unit.

18. The system of claim 13, wherein automatically recognizing, in the background mode, the image that contains visually represented text is initiated when the document is opened by user.

19. A non-transitory computer-readable medium having instructions stored thereon, the instructions comprising:
instructions to receive an electronic document, wherein the electronic document comprises an image that contains visually represents text, and wherein the electronic document lacks text data corresponding to the visually represented text of the image;
instructions to automatically recognize the image that contains visually represented text, wherein the automatic recognition occurs in a background mode such that display of the electronic document to a user is unaffected;
instructions to generate a text layer comprising recognized data, wherein the recognized data is based on the automatic recognition of the image that contains visually represented text;
instructions to insert the text layer behind the image that contains visual represented text such that it is hidden from the user when the electronic document is displayed, wherein the hidden text layer is configured to allow the user to perform a user operation on text corresponding to the recognized data; and
instructions to save, in a storage device, a result of the user operation as part of the electronic document.

20. The non-transitory computer-readable medium of claim 19, wherein the electronic document comprises at least one of an image-only PDF, a TIFF file, a JPEG file, a PNG file, a BMP file, a GIF file, and a RAW file.
